(19) United States
(12) Patent Application Publication
(10) Pub. No.: US 2005/0114331 A1
(43) Pub. Date: May 26, 2005

(54) Near-neighbor search in pattern distance spaces

(75) Inventors: Haixun Wang, Tarrytown, NY (US); Philip Shi-Lung Yu, Chappaqua, NY (US)

Correspondence Address: Ryan, Mason & Lewis, LLP, Suite 205, 1300 Post Road, Fairfield, CT, 06824, US

(73) Assignee: International Business Machines Corporation, Armonk, NY (US)

(21) Appl. No.: 10/722,776

(22) Filed: Nov. 26, 2003

(51) Int. Cl. G06F 7/00

(52) U.S. Cl. 707/6; 707/3

(57) ABSTRACT

Similarity searching techniques are provided. In one aspect, a method for use in finding near-neighbors in a set of objects comprises the following steps. Subspace pattern similarities that the objects in the set exhibit in multi-dimensional spaces are identified. Subspace correlations are defined between two or more of the objects in the set based on the identified subspace pattern similarities for use in identifying near-neighbor objects. A pattern distance index may be created. A method of performing a near-neighbor search of one or more query objects against a set of objects is also provided.

### FIELD OF THE INVENTION

The present invention relates to similarity searching techniques and, more particularly, to techniques for finding near-neighbors.

### BACKGROUND OF THE INVENTION

The efficient support of similarity queries in large databases is of growing importance to a variety of application, such as time series analysis, fraud detection in data mining and applications for content-based retrieval in multi-media databases. Techniques for similarity searching have been proposed. See, for example, R. Agrawal et al., Efficient Similarity Search in Sequence Databases, INTERNATIONAL CONFERENCE OF FOUNDATIONS OF DATA ORGANIZATION AND ALGORITHMS (FODO) 69-84 (1993), (hereinafter “Agrawal”). In Agrawal, similarity searching is conducted by clustering data in a given data set and looking for similarities.

One fundamental problem in similarity matching, for example, near-neighbor searching, is in finding a distance function that can effectively quantify the similarity between objects. For instance, the meaning of near-neighbor searches in high dimensional spaces has been questioned, due to the fact that, in these spaces, all pairs of objects are almost equidistant from one another for a wide range of data distributions and distance functions.

Much research has been focused on similarity matching and near-neighbor searching. Many researchers have handled the near-neighbor problem in a metric space, which is defined by a set of objects and a distance function satisfying the triangular inequality. For instance, in applications such as speech recognition, information retrieval and time-series analysis, near-neighbor searches are usually performed in a vector space under an L1 (Manhattan) or L2 (Euclidean) metric. Non-vector metric space is also frequently used in near-neighbor searches. For instance, an edit distance is used for string and deoxyribonucleic acid (DNA) sequence matching.

The triangular inequality property of the metric space is the foundation of many hierarchical approaches to solving the near-neighbor problem. Hierarchical data structures are constructed to recursively partition the space using the distance functions. Some representative hierarchical approaches include a generalized hyperplane tree (gh-tree) approach, a vantage point tree (vp-tree) approach and a geometric near-neighbor access tree (GNAT) approach.

For example, a gh-tree is constructed by picking two reference points at each node in the tree and grouping other points based on distances to the two reference points. With the vp-tree approach, space is broken up using spherical cuts. With the GNAT approach, the metric spaces are partitioned using k reference points and creating a k-way tree at each step.

The concept of a projected near-neighbor search has been proposed to find nearest neighbors in a relevant subspace of the entire space. Such an undertaking is much more difficult than the traditional near-neighbor problem because it performs searches in subspaces defined by an unknown combination of dimensions.

Near-neighbor searching does not yield clear results in high-dimensional spaces due to the fact that, for example, distance functions satisfying the triangular inequality are usually not robust to outliers, or to extremely noisy data. Therefore, it would be desirable to be able to perform effective and accurate similarity matching in non-metric spaces.

### SUMMARY OF THE INVENTION

The present invention provides similarity searching techniques. In one aspect of the invention, a method for use in finding near-neighbors in a set of objects comprises the following steps. Subspace pattern similarities that the objects in the set exhibit in multi-dimensional spaces are identified. Subspace correlations are defined between two or more of the objects in the set based on the identified subspace pattern similarities for use in identifying near-neighbor objects. A pattern distance index may be created.

In another aspect of the invention, a method of performing a near-neighbor search of one or more query objects against a set of objects comprises the following steps. A pattern distance index is created to identify subspace pattern similarities that the objects in the set exhibit in multi-dimensional spaces. Subspace correlations are defined between two or more of the objects in the set based on the identified subspace pattern similarities. The subspace correlations are used to identify near-neighbor objects among the query objects and the objects in the set.

A more complete understanding of the present invention, as well as further features and advantages of the present invention, will be obtained by reference to the following detailed description and drawings.

### BRIEF DESCRIPTION OF THE DRAWINGS

FIG. 1 is a diagram illustrating an exemplary method of finding near-neighbors in a set of objects according to an embodiment of the present invention;

FIG. 2 is a block diagram of an exemplary hardware implementation of a method of finding near-neighbors in a set of objects according to an embodiment of the present invention;

FIG. 3 are graphs illustrating the normalization of patterns in a subspace according to an embodiment of the present invention;

FIG. 4 is a graph illustrating use of a base of comparison during similarity matching according to an embodiment of the present invention;

FIG. 5 is a table illustrating sequences and suffixes derived from an exemplary dataset according to an embodiment of the present invention;

FIG. 6 is diagram illustrating an exemplary trie structure according to an embodiment of the present invention;

FIG. 7 is a detailed representation of a near-neighbor search in a given subspace defined by a continuous column according to an embodiment of the present invention;

FIG. 8 is an exemplary methodology for pattern distance index (PD-index) construction according to an embodiment of the present invention;

FIGS. 9A-B are diagrams illustrating the disk storage model of the PD-index according to an embodiment of the present invention;

FIG. 10 is an exemplary methodology for pattern matching according to an embodiment of the present invention;

FIG. 11 is a diagram illustrating an exemplary tree structure with pattern-distance links according to an embodiment of the present invention;

FIG. 12 is a diagram illustrating embedded ranges according to an embodiment of the present invention;

FIG. 13 is an exemplary methodology for near-neighbor searching according to an embodiment of the present invention;

FIG. 14A is a graph illustrating the expression levels of two genes which rise and fall together according to an embodiment of the present invention;

FIG. 14B is a graph illustrating genes which do not share any patterns in the same subspace according to an embodiment of the present invention;

FIG. 15A is a graph illustrating a data set wherein the dimensionality is fixed and the discretization granularity varies according to an embodiment of the present invention;

FIGS. 15B-C are graphs illustrating a data set wherein the discretization granularity is fixed and the dimensionality is varied according to an embodiment of the present invention;

FIG. 16A is a graph illustrating pattern matching in given subspaces according to an embodiment of the present invention;

FIG. 16B is a graph illustrating a near-neighbor search in subspaces beyond given dimensionalities according to an embodiment of the present invention;

FIG. 16C is a graph illustrating the impact of dimensionality and discretization granularity on a near-neighbor query according to an embodiment of the present invention; and

FIGS. 17A-B are graphs illustrating similarity matching for exemplary DNA micro-array data according to an embodiment of the present invention.

### DETAILED DESCRIPTION OF THE PREFERRED EMBODIMENTS

FIG. 1 is a diagram illustrating an exemplary method of finding near-neighbors in a set of objects. FIG. 1 provides an overview of the present techniques, each step of which will be described in detail throughout the description. In step 102 of FIG. 1, a pattern distance index is created for the objects. The creation of a pattern distance index will be described in detail below. The pattern distance index is then used to identify subspace pattern similarities that the objects in the set exhibit in multi-dimensional spaces. For example, given a set of objects D in a multi-dimensional space and a query object, objects are found in D that share coherent patterns with the query object in any subspace whose dimensionality is above a given threshold. The similarity cannot be captured by distance functions such as the Lₚ norm, nor by measures such as the Pearson correlation when applied on the entire space. Subspace pattern similarities in multi-dimensional spaces will be described in detail below.

In step 104 of FIG. 1, each of the objects may be represented by a sequence of pairs that indicates both a dimension and a value of the object in that dimension. The representation of an object by such a sequence of pairs is described in detail below. In step 106 of FIG. 1, the subspace dimensionality of one or more of the patterns in the pattern distance index may be determined. The subspace dimensionality may be used as an indicator of the degree of similarity between the objects. The determination of dimensionality will be described in detail below.

In step 108 of FIG. 1, pattern distance links may be defined, and used to create the pattern distance index, as will be described in detail below. In step 110 of FIG. 1, subspace correlations between one or more objects in the set, i.e., the distances between objects, are defined based on the subspace pattern similarities. Subspace correlations will be described in detail below. In step 112 of FIG. 1, the subspace correlations are used to determine near-neighbor objects in the set, as will be described in detail below.

Hence, the first challenge is to define a new distance function for subspace pattern similarity. The second challenge is to design an efficient methodology to perform near-neighbor queries in that setting.

Near-neighbor searching is important to many applications, including, but not limited to, scientific data analysis, fraud and intrusion detection and e-commerce. For example, in DNA microarray analysis, the expression levels of two closely related genes may rise and fall synchronously in response to a set of experimental stimuli. Although the magnitude of the gene expression levels may not be close, the patterns they exhibit can be very similar. Similarly, in e-commerce applications, such as collaborative filtering, the inclination of customers towards a set of products may exhibit certain pattern similarity, which is often of great interest to target marketing.

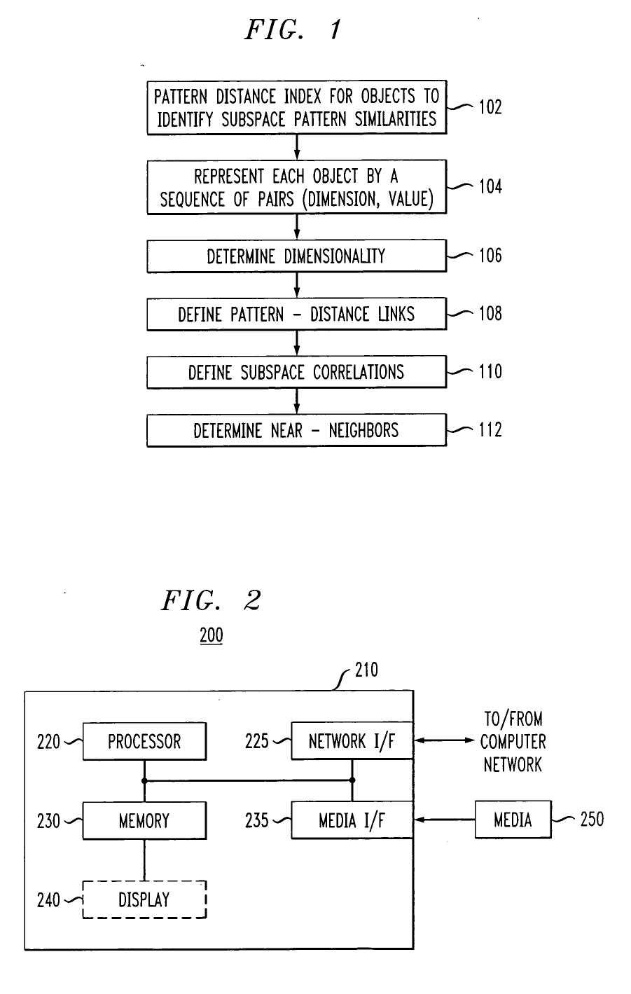

FIG. 2 is a block diagram of an exemplary hardware implementation of a near-neighbor analyzer 200 in accordance with one embodiment of the present invention. It is to be understood that apparatus 200 may implement the methodology described above in conjunction with the description of FIG. 1. Apparatus 200 comprises a computer system 210 that interacts with media 250. Computer system 210 comprises a processor 220, a network interface 225, a memory 230, a media interface 235 and an optional display 240. Network interface 225 allows computer system 210 to connect to a network, while media interface 235 allows computer system 210 to interact with media 250, such as a Digital Versatile Disk (DVD) or a hard drive.

As is known in the art, the methods and apparatus discussed herein may be distributed as an article of manufacture that itself comprises a computer-readable medium having computer-readable code means embodied thereon. The computer-readable program code means is operable, in conjunction with a computer system such as computer system 210, to carry out all or some of the steps to perform the methods or create the apparatus discussed herein. The computer-readable code is configured to implement a method for use in finding near-neighbors in a set of objects by the steps of identifying subspace pattern similarities that the objects in the set exhibit in multi-dimensional spaces; and defining subspace correlations between two or more of the objects in the set based on the identified subspace pattern similarities for use in identifying near-neighbor objects. The computer-readable medium may be a recordable medium (e.g., floppy disks, hard drive, optical disks such as a DVD, or memory cards) or may be a transmission medium (e.g., a network comprising fiber-optics, the world-wide web, cables, or a wireless channel using time-division multiple access, code-division multiple access, or other radio-frequency channel). Any medium known or developed that can store information suitable for use with a computer system may be used. The computer-readable code means is any mechanism for allowing a computer to read instructions and data, such as magnetic variations on a magnetic medium or height variations on the surface of a compact disk.

Memory 230 configures the processor 220 to implement the methods, steps, and functions disclosed herein. The memory 230 could be distributed or local and the processor 220 could be distributed or singular. The memory 230 could be implemented as an electrical, magnetic or optical memory, or any combination of these or other types of storage devices. Moreover, the term “memory” should be construed broadly enough to encompass any information able to be read from or written to an address in the addressable space accessed by processor 220. With this definition, information on a network, accessible through network interface 225, is still within memory 230 because the processor 220 can retrieve the information from the network. It should be noted that each distributed processor that makes up processor 220 generally contains its own addressable memory space. It should also be noted that some or all of computer system 210 can be incorporated into an application-specific or general-use integrated circuit.

Optional video display 240 is any type of video display suitable for interacting with a human user of apparatus 200. Generally, video display 240 is a computer monitor or other similar video display.

As was described above in conjunction with the description of step 102 of FIG. 1, a pattern distance index needs to be created. To create a pattern distance index, patterns are first defined in multi-dimensional spaces and then a new distance function may be introduced to measure subspace pattern similarity between objects.

Based on a certain distance function dist(•, •) that measures the similarity between two objects, the near-neighbors of a query object q within a given tolerance radius r, in a database D, are defined as:
NN(q, r)={p|pεD,dist(q, p)≦r}. (1)
The distance function dist(•, •) not only has a direct impact on the efficiency of the search of near-neighbors, more importantly, it also determines whether the near-neighbor search performed is meaningful or not, in certain situations.

FIG. 3 are graphs illustrating the normalization of patterns in a subspace. As shown in FIG. 3, u and v are two objects in dataset D. An issue that arises is how the pattern-based similarities in u and v are measured in a given subspace S, for example, S={a, b, c, d, e}. A straightforward approach is to normalize both objects u and v in subspace S, as is shown in FIG. 3, by shifting u and v by an amount of \overline{Uₛ} and \overline{Vₛ}, respectively, where \overline{Uₛ} (\overline{Vₛ}) is the average coordinate value of u(v) in subspace S.

After normalization, it may be checked whether u and v exhibit a pattern of good quality in subspace S. Namely, objects u, v ε D exhibit an ε-pattern* in subspace S ⊂ A if:

$${d}_{S} ( u , v ) = {max}_{iεS} \vert ( {u}_{i} - \overline{{u}_{S}} ) - ( {v}_{i} - \overline{{v}_{S}} ) \vert ≦ ε , \qquad ( 2 )$$

wherein

$$\overline{{u}_{S}} = \frac{1}{\vert S \vert} {Σ}_{iεS} {u}_{i} , \overline{{v}_{S}} = \frac{1}{\vert S \vert} {Σ}_{iεS} {v}_{i}$$

are average coordinate values of u and v in subspace S and ε≧0.

This definition of an ε-pattern*, although intuitive, may not be practical for a near-neighbor search in arbitrary subspaces. Near-neighbor queries usually rely on index structures to speed up the search process. The definition of ε-pattern*, given by Equation 2, above, uses not only coordinate values (i.e., uᵢ, vᵢ), but also average coordinate values in subspaces (i.e., \overline{uₛ}, \overline{vₛ}). It is unrealistic, however, to index average values for each of the 2^{|A|}subsets.

To avoid the problem of dimensionality, the definition of an ε-pattern*, as shown in Equation 2, above, may be relaxed by eliminating the need of computing average values. Instead of using the average coordinate value, the coordinate values of any column kεS may be used as the base for comparison. Given a subspace S and any column kεS, the following may be defined as:

$${d}_{k , S} ( u , v ) = {max}_{iεS} \vert ( {u}_{i} - {u}_{k} ) - ( {v}_{i} - {v}_{k} ) \vert \qquad ( 3 )$$

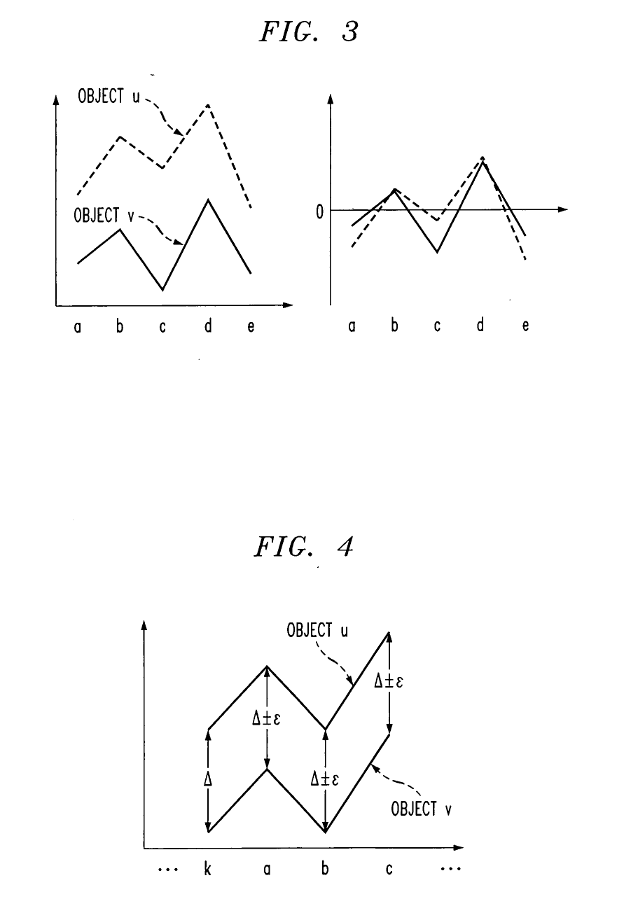

FIG. 4 is a graph illustrating use of a base of comparison during similarity matching. In FIG. 4, the intuition of d_{k,S} is shown. Dimension k is the base column. Two objects u and v satisfy d_{k,S}(u, v)≦ε if their difference in any dimension iεS is within ±ε of their difference in dimension k. It is easy to see that it is much less costly to compute and index objects by d_{k,S} than by d_{S}.

However, the choice of column k presents a problem. Namely, whether an arbitrary k affects the ability to capture pattern similarity. The following property may serve to relieve this concern. Specifically, if there exists kεS, such that d_{k,S}(u, v)≦ε, then:

$${∀}_{i} {εSd}_{i , S} ( u , v ) ≦ 2 ε and {d}_{S} ( u , v ) < 2 ε , \\ because , \\ \vert ( {u}_{j} - {u}_{i} ) - ( {v}_{j} - {v}_{i} ) \vert ≦ \vert ( {u}_{j} - {v}_{j} ) - ( {u}_{k} - {v}_{k} ) \vert + \vert ( {u}_{k} - {v}_{k} ) - ( {u}_{i} - {v}_{i} ) \vert \\ and \\ \vert ( {u}_{i} - \overline{{u}_{S}} ) - ( {v}_{i} - \overline{{v}_{S}} ) ≦ \frac{1}{\vert S \vert} {\sum }_{jεS} \vert ( {u}_{i} - {u}_{j} ) - ( {v}_{i} - {v}_{j} ) \vert . \qquad ( 4 )$$

Not only is the difference among base columns limited, Equation 4, above, shows that the difference between using Equation 2 and Equation 3 is bounded by a factor of two in terms of the quality of ε-pattern*. In the same light, if u and v exhibit an ε-pattern* in subspace S, then ∀ₖεS, and d_{k,S}(u, v)≦2ε. Thus, in order to find all ε-pattern*, d_{k,S}(u, v)<2ε can be used as the criteria and to prune the results, since Equation 3 is much less costly to compute.

In order to find patterns defined by a consistent measure, the base column k is fixed for any subspace S ⊂ A. It is assumed that there is a total order among the dimensions in A, that is c₁<c₂ . . . <cₙ, for cᵢεA, i=1 . . . n.

Given a subspace S, the least dimension, in terms of the total order, issued as the base column. Finally, the definition of ε-pattern* that induces an efficient implementation is deduced. Namely, objects u,v ε D exhibit an ε-pattern* in subspace S ⊂ A if:
d_{k,S}(u, v)≦ε, (5)
wherein k is the least dimension in S and ε≧0.

The ε-pattern* definition shown by Equation 5, above, focuses on pattern similarity in a given subspace. The distance between two objects may be measured when no subspace is specified. More often than not, it is not important over which subspace two objects exhibit a similar pattern, but rather, how many dimensions the pattern spans. As was highlighted above in conjunction with the description of step 106 of FIG. 1, the subspace dimensionality of the patterns may be determined. The dimensionality of the subspace is an indicator of the degree of the similarity. In other words, the larger the dimensionality, the more convincing the similarity is, which will be highlighted by an exemplary data set provided below.

Given two objects u,v ε D and some ε≧0, the pattern distance between u and v is r, pattern distance pdist(•, •) may be defined as follows:
pdist(u, v)=r, (6)
if i) there exists a subspace S∈ A wherein u and v exhibit an ε-pattern* and r=|A|−|S| and ii) no subspace S′ exists such that u and v exhibit an ε-pattern* in S′ and |S′|>|S|.

Thus, two objects that exhibit an ε-pattern* in the entire space A will have zero pattern distance. The pattern distance is negatively proportional to the dimensionality of the subspace in which the two objects form an ε-pattern*.

Note that the pattern distance defined above is non-metric, in that it does not satisfy the triangular inequality. One object can share ε-patterns* with two other objects in different subspaces. The sum of the distances to the two objects might be smaller than the distance between the two objects, which may not share synchronous patterns in any subspace. Using non-metric distances makes it easier to capture pattern similarity existing only in subspaces. But on the other hand, using non-metric distances poses challenges to near-neighbor search, as hierarchical approaches for near-neighbor searches do not work in non-metric spaces.

Two tasks of similarity searches include, 1) Given an object q and a subspace defined by a set of columns S, find all objects that share an ε-pattern* with q in S (a near-neighbor search conducted in any given subspace), and 2) Given an object q and a tolerance radius r, find NN(q, r) in dataset D:
NN(q, r)={uεD|pdist(q, u)≦r}. (7)
A couple examples will be provided below to address instances of the above tasks.

As described above in conjunction with the description of step 102 of FIG. 1, a pattern distance index (PD-Index) may be created to support fast pattern matching and near-neighbor searching. The PD-index may be created as follows. As was described above in conjunction with the description of step 104 of FIG. 1, each object uεD is represented as a sequence of (column, value) pairs. For each suffix of the sequence, a base-column aligned suffix is derived and inserted into a trie structure. The trie structure is similar to tree structures used for weighted subsequence matchings. See, for example, H. Wang et al., Indexing Weighted Sequences in Large Databases, ICDE (2003), the disclosure of which is incorporated by reference herein. The present techniques involve finding near neighbors in arbitrary subspaces.

The trie supports matching of patterns defined on a column set composed of a continuous sequence of columns, S={cᵢ, cᵢ₊₁, . . . , cᵢ₊ₖ}. To find patterns in any subspace efficiently, a PD-index is created on top of the trie. The PD-index provides the capability to support near-neighbor searches based on subspace pattern similarities. The trie is employed as an intermediary structure to facilitate the building of the PD-index. The trie embodies a compact index to all the distinct, non-empty, base-column aligned objects in D. Various approaches to build tries or suffix trees in linear time have been developed.

For example, a linear-time, on-line suffix tree construction methodology was developed in E. Ukkonen, Constructing Suffix-Tree On-Line in Linear Time, ALGORITHMS, SOFTWARE, ARCHITECTURE: IPROCESSING, 484-92 (1992), the disclosure of which is incorporated by reference herein.

A sequential representation of the data is first introduced, and then used to demonstrate the process of constructing the PD-index. Given a dataset D in space A={c₁, c², . . . , cₙ}, wherein c₁<c₂<. . . <cₙ is a total order, each object u ε D is represented as a sequence of (column, value) pairs, that is u=(c₁, u₁), (c₂, u₂), . . . , (cₙ, uₙ). A suffix of u starting with column cᵢ, is denoted by (cᵢ, uᵢ), (cᵢ₊₁, uᵢ₊₁), . . . , (cₙ, uₙ), wherein one is less than or equal to i which is less than or equal to n. Using the first column in each suffix as a base column, a base-column aligned suffix is derived by subtracting the value of the base (first column) from each column value in the suffix. f(u, i) is used to denote the base-column aligned suffix of u that begins with the ith column:
f(u, i)=(cᵢ, 0), (cᵢ₊₁, uᵢ₊₁−uᵢ), . . . , (c_{K}, u_{K}−uᵢ). (8)

Each base-column aligned suffix f(u, i) is then inserted into a trie, i.e., according to the following exemplary process. If database D is composed of the following two objects defined in space A={c₁, c₂, c₃, c₄, c₅}, such that:

| obj | c₁ | c₂ | c₃ | c₄ | c₅ |
|---|---|---|---|---|---|
| #1 | 3 | 0 | 4 | 2 | 0 |
| #2 | 4 | 1 | 5 | 3 | 6 |

then each object may be represented by a sequence of (column, value) pairs. For instance, object #1 in D can be represented by: (c₁, 3), (c₂, 0), (c₃, 4), (c₄, 2), (c₅, 0).

The first column in the sequence is used as a base column, and a base-column aligned suffix is derived by subtracting the value of the base column from each value in the suffix. Thus, (c₁, 0),(c₂, −3),(c₃, 1), (c₄, −1),(c₅, −3) are the results.

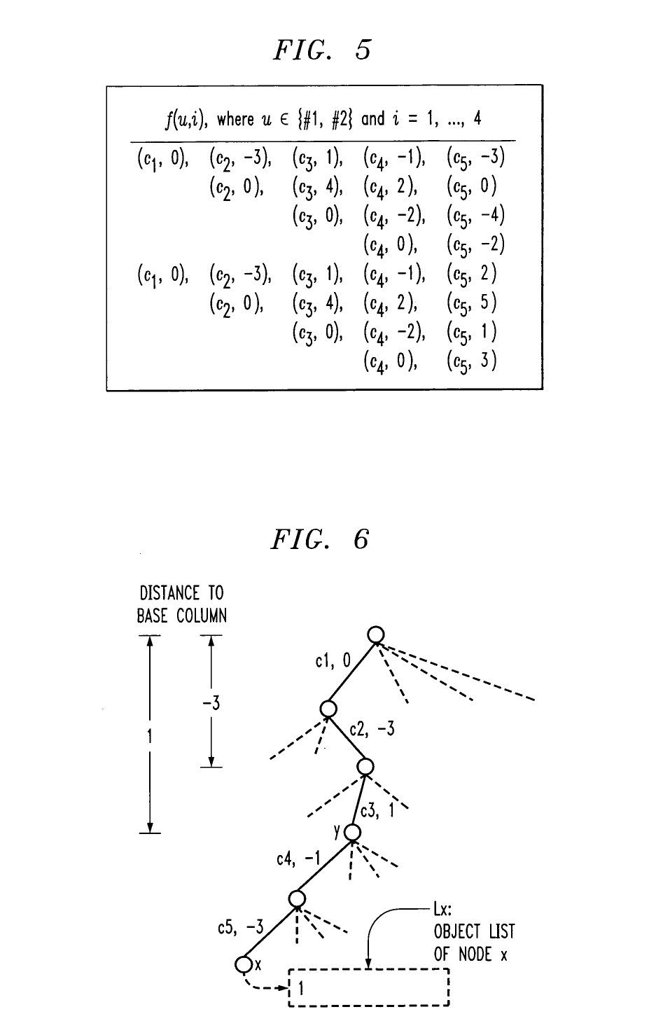

The same may be done to each suffix (of length greater than or equal to two) of the object. FIG. 5 is a table illustrating sequences and suffixes derived from an exemplary dataset. FIG. 5 shows all the base-column aligned suffices derived from these two objects used to exemplify the trie insertion process.

The base-column aligned suffixes are inserted into a trie. FIG. 6 is a diagram illustrating an exemplary trie structure. Namely, FIG. 6 demonstrates the insertion of the sequence f(#1, 1)=(c₁, 0), (c₂,−3), (c₃, 1), (c₄, −1), (c₅, −3).

Each leaf node n in the trie maintains an object list Lₙ. Assuming the insertion of f(#1, 1) leads to node x, which is under arc (e,−3), 1 (object #1) is appended to object list Lₓ.

The PD-Index may be built over the trie structure. Namely, the trie structure enables one to find near-neighbors of a query object q=(c₁, v₁), . . . , (cₙ, vₙ) in a given subspace S, provided S is defined by a set of continuous columns, i.e.,S={cᵢ, cᵢ+1, . . . , c_{i+k}.}

If ε equals zero, all that needs to be done is to follow path (cᵢ, 0), (cᵢ₊₁, vᵢ₊₁−vᵢ), . . . , (cᵢ₊ₖ, vᵢ₊ₖ−vᵢ) in the trie shown in FIG. 6, and when a certain node x at the end of the path is reached, objects are returned in the object lists of those leaf nodes that are descendants of x (including x, if x is a leaf node). If ε is greater than zero, multiple paths may need to be traversed at each level.

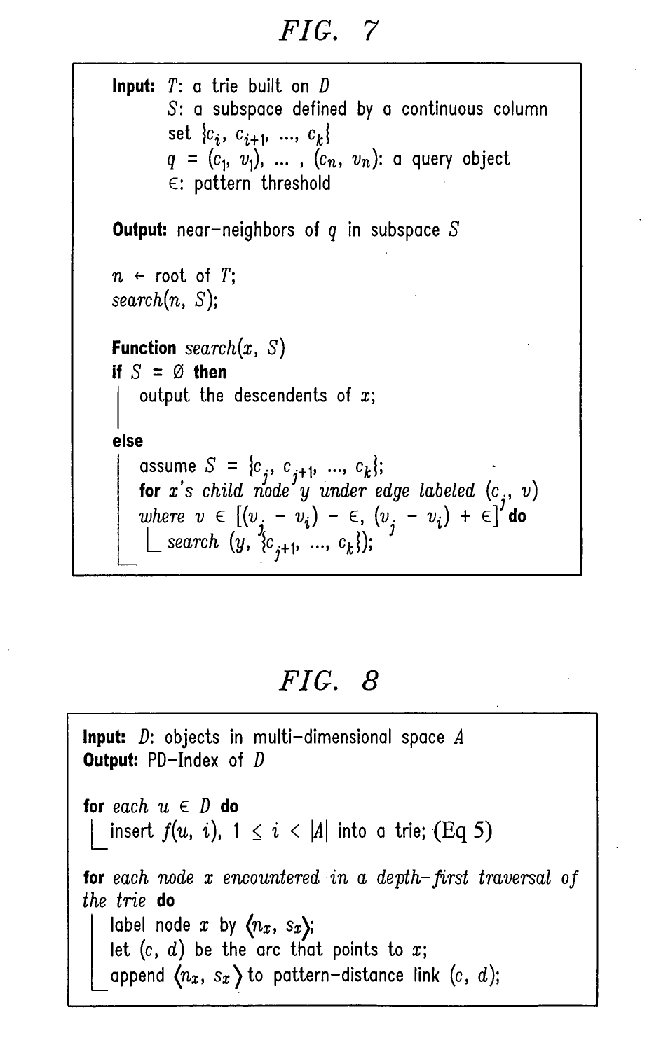

FIG. 7 is a detailed representation of a near-neighbor search in a given subspace defined by continuous columns. Namely, the methodology presented in FIG. 7 provides a formal description of the steps outlined in FIG. 1. The methodology shown in FIG. 7 finds all objects whose value difference between column cⱼ and cᵢ is within region (vⱼ−vᵢ)±ε, where j=i, i+1 , . . . , i+k.

The methodology shown in FIG. 7, however, only finds near-neighbors in a given subspace defined by a set of continuous columns. In the methodology shown in FIG. 7, at each step j, one can only go directly to the node under edge (cⱼ₊₁, •). To find a descendent node under edge (cₖ, •), wherein k is greater than j, requires one to traverse the subtree under the current node, which is time-consuming. The PD-index, described below, allows jumping directly to nodes under (cₖ, •), wherein k is greater than j. Thus, near-neighbors may be efficiently found in any given subspace. Furthermore, near-neighbors in any subspace whose dimensionality is larger than a given threshold requires additional index structures. The following two steps are used to build the PD-index on top of a trie.

First, after all sequences are inserted, a pair of labels <nₓ, Sₓ> are assigned to each node x, wherein nₓ is the prefix-order of node x in the trie (starting from zero, which is assigned to the root node), and Sₓ is the number of descendent nodes of x.

Next, as was highlighted above in conjunction with the description of step 108 of FIG. 1, pattern-distance links are created for each (col, dist) pair, wherein colεA, distε{−ξ+1, . . . , ξ−1}, and ξ is the number of distinct column values. ξ is also regarded as a discretization parameter, or the number of bins the numerical values are discretized into. The links are constructed by a depth-first walk of the suffix trie. When a node x under arc (col, dist) is encountered, the <nₓ, Sₓ> label on x is appended to the pattern-distance link for pair (col, dist). Thus, a pattern distance link is composed of nodes that have the same distance from their base columns (root node). As was highlighted above in conjunction with the description of step 110 of FIG. 1, subspace correlations between one or more objects in the set, i.e., the distances between objects, are defined.

The labeling scheme and the pattern-distance links have the following properties. First, if nodes x and y are labeled <nₓ, Sₓ> and <n_{y}, S_{y}> respectively, and nₓ<n_{y}≦nₓ+Sₓ, then y is a descendent node of x. Second, nodes in any pattern-distance links are ordered by their prefix-order number. Third, for any node x, the descendants of x in any pattern-distance link are contiguous in that link.

The first and second properties, above, are due to the labeling scheme which is based on depth-first traversal. Regarding the third property, note that if nodes u, . . . , v, . . . , w are in a pattern-distance link (in that order), and u, v are descendants of x, then nₓ<nᵤ<nᵥ<n_{w}≦nₓ+Sₓ which means v is also a descendent of x. The above properties enable the use of range queries to find descendants of a given node in a given pattern-distance link.

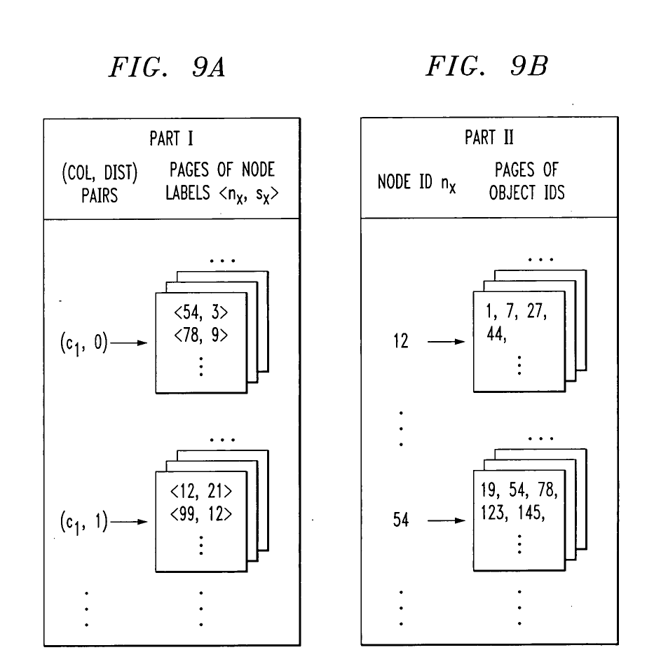

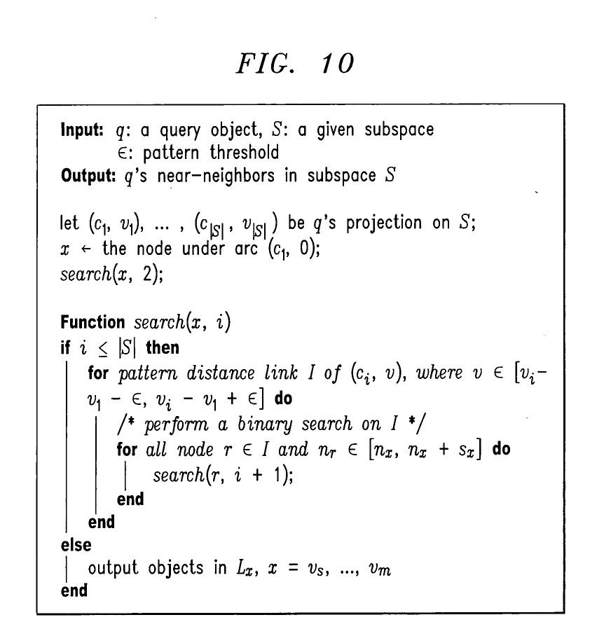

FIG. 8 is an exemplary methodology for PD-index construction. Namely, the methodology shown in FIG. 8 summarizes the index construction procedure. The PD-Index is composed of two major parts: Part I, arrays of <nₓ,Sₓ> pairs for pattern-distance links; and Part II, object lists of leaf nodes. FIGS. 9A-B are diagrams illustrating the disk storage model of the pattern distance index. As shown in FIGS. 9A-B, the pattern index arrays are organized in ascending order of (col, dist), and the object lists in ascending order of the prefix-order number nₓ of the nodes. Both of the structures are one dimensional buffers, which are straightforward to implement for disk paging. Since nₓ of the nodes are in ascending order in pattern distance links, storing them consecutively in an array binary search can be useful to help locate nodes whose prefix-order numbers are within a given range. Note, the tree structure (parent-child links) is not stored in the index. Each index shown in FIGS. 9A-B contains complete information for efficient pattern matching and near-neighbor search.

The time complexity of building the PD-index is O(|D∥A|). The Ukkonen methodology builds a suffix tree in linear time. The construction of the trie for pattern-distance indexing is less time consuming because the length of the indexed subsequences is constrained by |A|. Thus, it can be constructed by a brute-force methodology in linear time. See, for example, E. M. McCreight, A Space-Economical Suffix Tree Construction Algorithm, JOURNAL OF THE ACM, 23(2):262-272 (April 1976), the disclosure of which is incorporated by reference herein.

The space taken by the PD-Index is linearly proportional to the data size. Since each node appears once, and only once, in the pattern distance links, the total number of entries in Part I equals the total number of nodes in the trie, or O(|D∥A|²) in the worst case (i.e., if none of the nodes are shared by any subsequences). On the other hand, there are exactly |D|(|A|−1) objects stored in Part II. Thus, the space is linearly proportional to the data size |D|.

The index construction methodology assumes that static datasets are being managed. To support dynamic data insertions, the labeling scheme needs to be modified. One option is to use pre-fix paths (i.e., starting from the root node) as the labels for the tree nodes. Also, B+Trees can be used instead of consecutive buffers in order to allow dynamic insertions of nodes to the pattern-distance links.

As was highlighted above in conjunction with the description of step 112 of FIG. 1, near-neighbors are determined in a given subspace. For example, as was provided above, given an object q and a subspace defined by a set of columns S, all objects may be found that share an ε-pattern* with q in S. Near-neighbors are found in a given subspace using the PD-index. For instance, assuming a query object q, wherein q=(a, 3), (b, 7), (c, 7), (d, 9), (e, 2), the goal is to find the near-neighbors of q in a given subspace S defined by column set {a, c, e}. It is easy to see that only the projection of q on S, q′=(a, 3), (c, 7), (e, 2), is relevant.

The first column of q′ is used as the base column, resulting in (a, o), (c, 4), (e, −1). The pattern distance link of (a, 0) is started with, which contains only one node. It is assumed that the label of the pattern distance link of (a, 0) is <20, 180>, meaning that sequences starting with column a are indexed by nodes from 20 to 200. Next, pattern-distance link (c, 4) is consulted which contains all the c nodes that are four units away from their base column (root node). However, only those nodes that are descendants of (a, 0) are of interest. According to the property of pattern-distance links, those descendants are contiguous in the pattern-distance link and their prefix-order numbers are inside range [20, 200]. Since the nodes in the buffer are organized in ascending order of their prefix-order numbers, the search is carried out as a range query in log time.

Suppose three nodes are found, u=<42, 9>, v=<88, 11> and w=<102, 18>, in that range. The next pattern-distance link (e, −1) is consulted, and the process is repeated for each of the three nodes. Assume node x is a descendent of node u, node y a descendent of node v and no nodes in pattern distance link of (e, −1) are descendants of node w. All the columns in S are now matched, and the object lists of nodes x, y and their descendants contain offsets for the query.

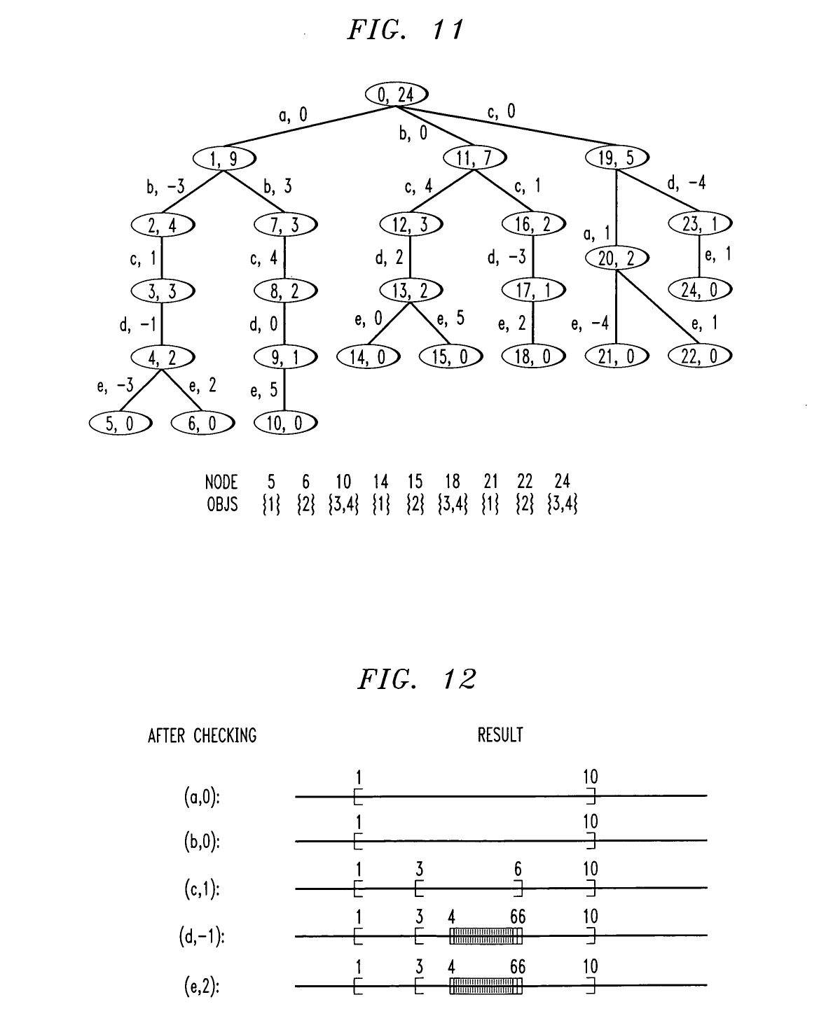

FIG. 10 is an exemplary methodology for pattern matching. The methodology shown in FIG. 10 outlines the searching of near-neighbors in a given subspace (defined by an arbitrary set of columns). Here, the purpose of having the pattern distance links is demonstrated. It enables jumping directly to the next relevant column in the given subspace. In a traditional suffix trie, only the tree branches may be followed. As a result, the tree structure is not needed in the searching, since the pattern-distance links already contain the complete information for pattern matching.

In another example, as was also provided above, given an object q and a tolerance radius r, NN(q, r) in dataset D are found. Each node x in the trie represents a coverage, which is given by range r(x)=[nₓ, nₓ+Sₓ] (assuming x is labeled <nₓ, Sₓ>). Near-neighbor searching within distance radius r consists of finding each leaf node whose pre-order number is inside at least |A|−r ranges associated with the query object.

More formally, the coverage property is introduced as follows. Let q be a query object, and pεD be a near-neighbor of q (within radius r, or pdist(p, q)≦r). Hence, there exists a subspace S, |S|=|A|−r, in which p and q share a pattern. Consider f(q, i)=(cᵢ, 0), . . . , (cₖ, qₖ−qᵢ), . . . , (c_{|A|}, q_{|A|}−qᵢ). Each element (cₖ, qₖ=qᵢ) of f(q, i) corresponds to a pattern distance link, which contains a set of nodes. Let P(q, i) denote the set of all nodes that appear in the pattern distance links of the elements in f(q, i), and let

$$P ( q ) = {⋃}_{iεA} P ( q , i ) .$$

According to the coverage properties of the present techniques, for any object p that shares a pattern with query object q in subspace S, there exists a set of |S| nodes {x₁, . . . , x_{|S|}}⊂P(q), and a leaf node y that contains p(pεL_{y}), such that n_{y}εr(x₁)⊂ . . . r(x_{|S|}), where n_{y} is the prefix-order of node y. Namely, cᵢ is assumed to be the first column of S (that is, there does not exist any cᵢ εS such that j is less than i). It is also assumed that the insertion of f(p, i) follows the path consisting of nodes xᵢ, xᵢ₊₁, . . . , x_{|A|}, which leads to r(x_{|A|})⊂ . . . ⊂r(xᵢ₊₁)⊂ r(xᵢ). Node xⱼ is assumed to be in the pattern-distance list of (cⱼ, pⱼ−pᵢ). Since p and q share pattern in S, (cⱼ, pⱼ−pᵢ)=(cⱼ, pⱼ−qᵢ) holds for at least |S| different columns, which means |S| of the nodes in xᵢ, xᵢ₊₁, . . . , x_{|A|} also appear in P(q, i)⊂P(q).

This illustrates that in order to find objects that share patterns with q in subspace S, of which cᵢ is the first column, only the ranges of the objects in P(q,i) need be considered, instead of in the entire object set P(q). The reverse of the coverage property is also true, i.e., for any {x₁, . . . , xₙ}⊂P(q) satisfying r(x₁)⊂ . . . ⊂r(xₙ), any object εLₓ_{₁} is a near-neighbor of q with distance r≦|A|−n.

Based on the coverage property, to find NN(q, r), leaf nodes need to be found with a pre-order number that is inside at least |A|−r nested ranges. A near-neighbor search is performed iteratively. At the ith step, objects are found that share patterns with q in subspace S, of which cᵢ is the first column. During that step, only ranges of objects in P(q, i) need be considered. The search process may be demonstrated with an exemplary data set. For example, given a query object q=(a, 1), (b, 1), (c, 2), (d, 0), (e, 3), NN(q, 2) may be found in D (see Table 1, below).

In other words, given ∀pεNN(q, 2), p and q must share a pattern in three or higher-dimensional space (|A|−2=3).

TABLE 1

| obj. | a | b | c | d | e |
|---|---|---|---|---|---|
| 1 | 3 | 0 | 4 | 2 | 0 |
| 2 | 4 | 1 | 5 | 3 | 6 |
| 3 | 1 | 4 | 5 | 1 | 6 |
| 4 | 0 | 3 | 4 | 0 | 5 |

A tree structure built from the data is shown in FIG. 11. Namely, FIG. 11 is a diagram illustrating an exemplary tree structure with pattern-distance links. In FIG. 11, a labeled suffix trie is shown built on D. FIG. 11 also shows the object lists associated with each leaf node of the suffix trie. Note, that for simplicity, suffixes of lengths less than three were not included in FIG. 11. Not including suffixes of length less than three did not affect the results wherein only patterns in three or higher-dimensional space were sought.

f(q, 1) is started with. That is, patterns in subspaces that contain column a (the first column of A) are sought, i.e., f(q, 1)=(a, 0), (b, 0), (c, 1), (d, −1), (e, 2).

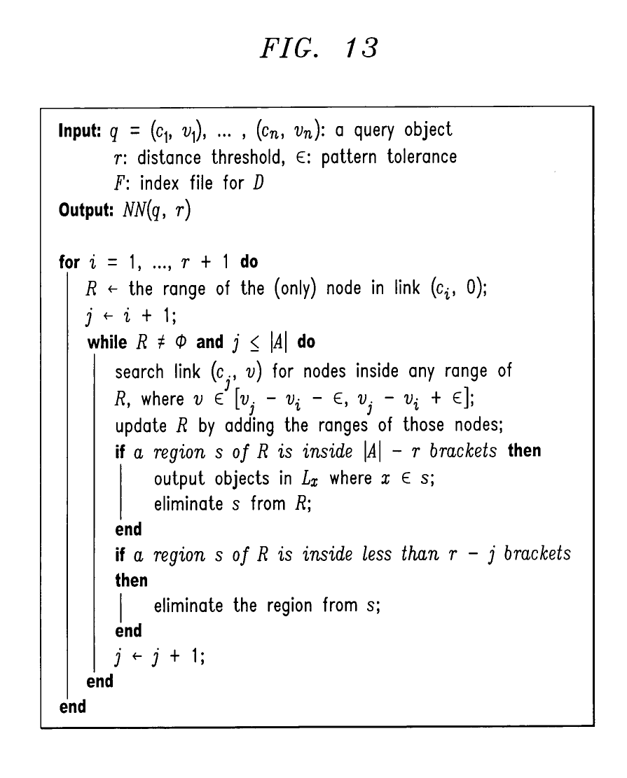

For each element in f(q, 1), the corresponding pattern-distance link are consulted and the labels of the nodes in the link are recorded. For instance, (a, 0) finds one node, which is labeled <1, 9>. The node is recorded in FIG. 12. FIG. 12 is a diagram illustrating embedded ranges. For the remaining elements of f(q, 1), the search is confined within that range, since subspaces are being sought where column a is present. The pattern-distance link of elements in f(q, 1) are consulted one by one. After (b, 0), (c, 1) and (d,−1) are consulted and the results recorded, region [4, 6] is found inside three brackets, as shown in FIG. 12.

This means that objects in the leaf nodes whose prefix-order are in range [4, 6] already match the query object in a three-dimensional space. To find what those objects are, a range query [4, 6] is performed in the object list table shown in FIG. 11, which returns object 1 and 2, belonging to leaf node 5 and 6, respectively. The two objects share a pattern with q in three-dimension space {a, c, d}. The process is repeated for f(q, 2), and so on.

In essence, the searching process maintains a set of embedded ranges represented by brackets, as shown in FIG. 12, and the goal is to find regions within |A|−r brackets, wherein r is the radius of the near-neighbor search (in this case r equals two). The performance of the search can be greatly improved by dropping those regions from further consideration if i) all nodes inside the region already satisfy the query, or ii) no node inside the region can possibly satisfy the query. First, more specifically, a region inside less than r-i brackets, after the ith dimension of A is checked, is discarded. It is easy to see that such regions will not be inside |A|−r brackets after all the remaining |A|−i dimensions are checked. Second, if a region is already inside |A|−r brackets, the objects in the leaf nodes within that region are output, and the region (unless the user wants the output objects ordered by their distance to the query object) is discarded.

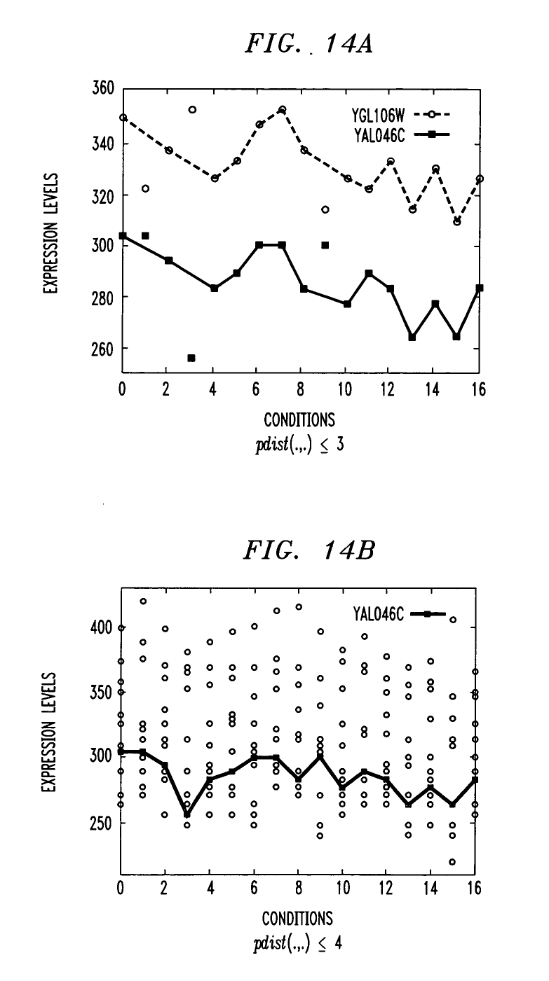

For instance, in FIG. 12, after the range of [4, 6] is returned, only region [3, 4] shall remain before (e, 2) is checked. FIG. 13 is an exemplary methodology for near-neighbor searching. The methodology shown in FIG. 13 gives a formal description of the optimization process.

A sample dataset is used to demonstrate the queries of interest in a deoxyribonucleic acid (DNA) microarray analysis. Table 2, below, shows a small portion of yeast expression data, wherein entry dᵢⱼ represents the expression level of gene i in sample j. Investigations show that, more often than not, several genes contribute to a disease, which motivates researchers to identify genes with expression levels that rise and fall synchronously under a subset of conditions. That is, whether the genes exhibit fluctuation of a similar shape when conditions change.

TABLE 2
Expression data of yeast genes

| | CH1I | CH1B | CH1D | CH2I | CH2B |
|---|---|---|---|---|---|
| VPS8 | 401 | 281 | 120 | 275 | 298 |
| SSA1 | 401 | 292 | 109 | 580 | 238 |
| SP07 | 228 | 290 | 48 | 285 | 224 |
| EFB1 | 318 | 280 | 37 | 277 | 215 |
| MDM10 | 538 | 272 | 266 | 277 | 236 |
| CYS3 | 322 | 288 | 41 | 278 | 219 |
| DEP1 | 317 | 272 | 40 | 273 | 232 |
| NTG1 | 329 | 296 | 33 | 274 | 228 |

As shown in Table 2, above, the expression levels of three genes, VPS8, CYS3 and EFB1, rise and fall coherently under three different conditions. Given a new gene, biologists are interested in finding every gene with an expression level under a certain set of conditions rise and fall coherently with those of the new gene, as such discovery may reveal connections in gene regulatory networks. As can be seen, these pattern similarities cannot be captured by distance functions, such as Euclidean functions, even if they are applied in the related subspaces.

According to the teachings herein, the concept of the near-neighbor may be extended to the above DNA microarray example. Genes VPS8, CYS3 and EFB1 are said to be near-neighbors in the subspace defined by conditions {CH1I, CH1D, CH2B}, as the genes manifest a coherent pattern therein. For a given query object, two types of near-neighbor queries can be asked. The simple type aims at finding the near-neighbors of the query object in any given subspace. A more general and challenging case is to find near-neighbors in any subspace, provided the dimensionality of the subspace is above a given threshold.

Here, the DNA microarray example may be used to demonstrate two types of near-neighbor queries. Further, as was described above, the following exemplary searches illustrate the similarity search tasks of: 1) Given an object q and a subspace defined by a set of columns S, find all objects that share an ε-pattern* with q in S (a near-neighbor search conducted in any given subspace), and 2) Given an object q and a tolerance radius r, find NN(q,r) in dataset D.

In a first instance, near-neighbor searches may be conducted in any given subspace. All genes are found that have expression levels in sample CH1I of about 100 units higher than that in sample CH2B, 280 units higher than that in sample CH1D and 75 units higher than that in sample CH2I. In this example, near-neighbors are searched for in a given subspace defined by column set {CH1I, CH2B, CH1D, CH2I}. Multi-dimensional index structures (e.g., the R-Tree family), which are often used to speed up traditional near-neighbor searches, cannot be applied directly, since they index exact attribute values, not their correlations.

In a second instance, a new gene is given for which the conditions under which it might manifest coherent patterns with other genes is not known. This new gene might be related to any gene in the database, as long as both of them exhibit a pattern in some subspace. The dimensionality of the subspace is often an indicator of the degree of their closeness (i.e., similarity), that is, the more columns the pattern spans the closer the relation between the two genes. This situation may be modeled as follows. Given a gene q and a dimensionality threshold r, all genes may be found with expression levels that manifest coherent patterns with those of q in any subspace S, wherein |S|≧r.

Similarly, an exemplary e-commerce collaborative filtering system may be presented as follows. In target marketing, customer behavior patterns (i.e., purchasing and browsing) provide clues to making proper recommendations to customers. As an example, assume customers give ratings (from zero to nine, nine being the highest score) to movies they have purchased.

TABLE 3
Rating by customers of movies A-F

| customer | A | B | C | D | E | F |
|---|---|---|---|---|---|---|
| #1 | 0 | 3 | 5 | 4 | 9 | 1 |
| #2 | 5 | 9 | 2 | 1 | — | 9 |
| #3 | 2 | — | 7 | 6 | — | — |

If one movie recommendation is permitted to be made to a particular customer, it is beneficial to find the movie that interests that customer the most. Regarding customer #3, for example, it may be determined which of the other customers are the near-neighbors of customer #3 in terms of movie taste. There is a reason to believe customer #3 and customer #1 share a similar taste, because their ratings of movies A, C and D exhibit a coherent pattern, although the ratings themselves are not close. Based on this knowledge, movie E may be recommended to customer #3, because movie E is given a rating of nine by customer #1.

Thus, the recommendation system relies on a near-neighbor search that finds objects sharing subspace pattern similarity. The confidence of the recommendation depends on the degree of similarity, and as in this case, the confidence of the recommendation can be measured by the number of the movies the two customers rate consistently.

As shown in Table 3, above, traditional distance functions, such as a Euclidean norm, cannot measure pattern-based similarity. With the present distance measure, the concept of a near-neighbor relationship may be extended to cover a wide range of applications, including, but not limited to, scientific data analysis, collaborative filtering as well as any application wherein pattern-based similarity carries significant meaning. Near-neighbor searches may then be performed by pattern similarity. Traditional spatial access methods for speeding up nearest neighbor search cannot be used for pattern similarity matching because these methods depend on metric distance functions satisfying the triangular inequality. Experiments show that the present techniques are effective and efficient, and outperform alternative methodologies (based on an adaptation of the R-Tree index) by an order of magnitude.

As was described above, a larger dimensionality results in a more convincing similarity. Using the data provided in Table 3, above, as an example, customer #1 is more similar to customer #3 than to customer #2, because the pattern exhibited by customer #1 and customer #3 is in a subspace defined by a three dimension set ({A, C, D}), while the latter a two dimension set ({C, D}).

The present techniques focus on solving the near-neighbor problem in non-metric spaces that do not satisfy the triangular inequality property. As described above in conjunction with the description of step 110 of FIG. 1, a correlation, i.e., the distance, between two objects is defined based on the similarity of the patterns the objects exhibit in arbitrary subspaces. Such similarity has been identified by recent research to exist in deoxyribonucleic acid (DNA) microarray analysis and collaborative filtering, and a new model called pCluster has been proposed to find clusters based on pattern similarity.

However, the near-neighbor problem requires an efficient, sublinear solution. As was alluded to above, the difficulties faced are two-fold. First, the dimensionality issue is inherited from the projected nearest neighbor search problem, which endeavors to locate nearest neighbors in subspaces. See, for example, A. Hinneburg et al., What is the Nearest Neighbor in High Dimensional Spaces?, VLDB (2000), the disclosure of which is incorporated by reference herein. The difficulties also include problems arising from non-metric spaces, as traditional hierarchical approaches, i.e., the generalized hyperplane tree (gh-tree) approach, the vantage point tree (vptree) approach and the geometric near-neighbor access tree (GNAT) approach, cannot be used for near-neighbor searches in non-metric spaces that violate the triangular inequality property.

### EXAMPLES

The PD-Index was tested with both synthetic and real life data sets on a Linux machine with a 700 megahertz (MHz) central processing unit (CPU) and 256 megabyte (MB) main memory.

Gene expression data are generated by DNA chips and other micro-array techniques. The data set is presented as a matrix. Each row corresponds to a gene and each column represents a condition under which the gene is developed. Each entry represents the relative abundance of the messenger ribonucleic acid (mRNA) of a gene under a specific condition. The yeast micro-array is a 2,884×17 matrix (i.e., 2,884 genes under 17 conditions). The mouse chromosomal-DNA (cDNA) array is a 10,934×49 matrix (i.e., 10,934 genes under 49 conditions) and is pre-processed in the same way.

Synthetic data are obtained wherein random integers are generated from a uniform distribution in the range of 1 to ξ. |D| represents the number of objects in the dataset and |A| the number of dimensions. The total data size is 4|D∥A| bytes.

Search results are shown of the near-neighbor search over the yeast microarray data, where the expression levels of the genes (of range zero to 600) have been discretized into ξ equals 30 bins. See, for example, Y. Cheng et al., Biclustering of Expression Data, PROC. OF 8TH INTERNATIONAL CONFERENCE ON INTELLIGENT SYSTEM FOR MOLECULAR BIOLOGY (2000), the disclosure of which is incorporated by reference herein. It is assumed that the genes related to gene YAL046C are of interest.

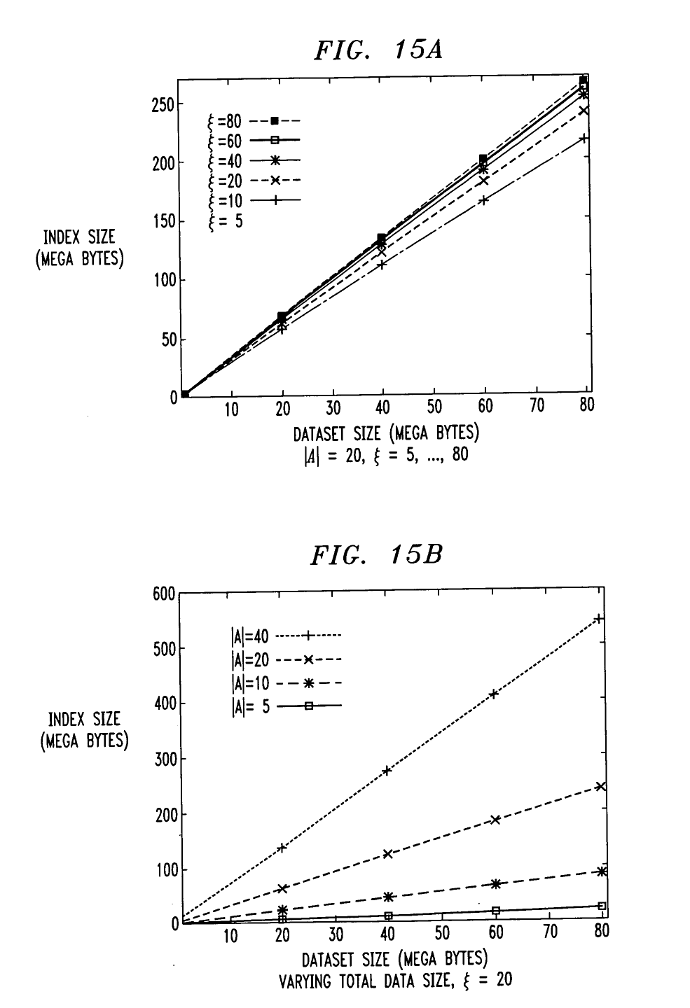

Let ε equal 20 (or one after discretization). It is found that one gene, YGL106W, within pattern distance 3 of gene YAL046C, i.e., YAL046C and YGL106W, exhibits an ε-pattern* in a subspace of dimensionality 14. This is illustrated by FIG. 14A which is a graph illustrating the expression levels of two genes which rise and fall together. The graph in FIG. 14A illustrates that, except under conditions 1, 3, and 9 (CH1B, CH2I and RAT2), the expression levels of the two genes rise and fall in sync.

FIG. 14B is a graph illustrating genes which do not share any patterns in the same subspace. Namely, FIG. 14B shows 11 near-neighbors of YAL046C found with a distance radius of four. That is, except for four columns, each of the 11 genes shares an ε-pattern* with YAL046C. It turns out that no two genes share ε-patterns* with YAL046C in the same subspace. Naturally, these genes do not show up together in any subspace cluster discovered by methodologies such as bi-cluster. Thus, a subspace near-neighbor search may provide insights to understanding their interrelationship overlooked by previous techniques.

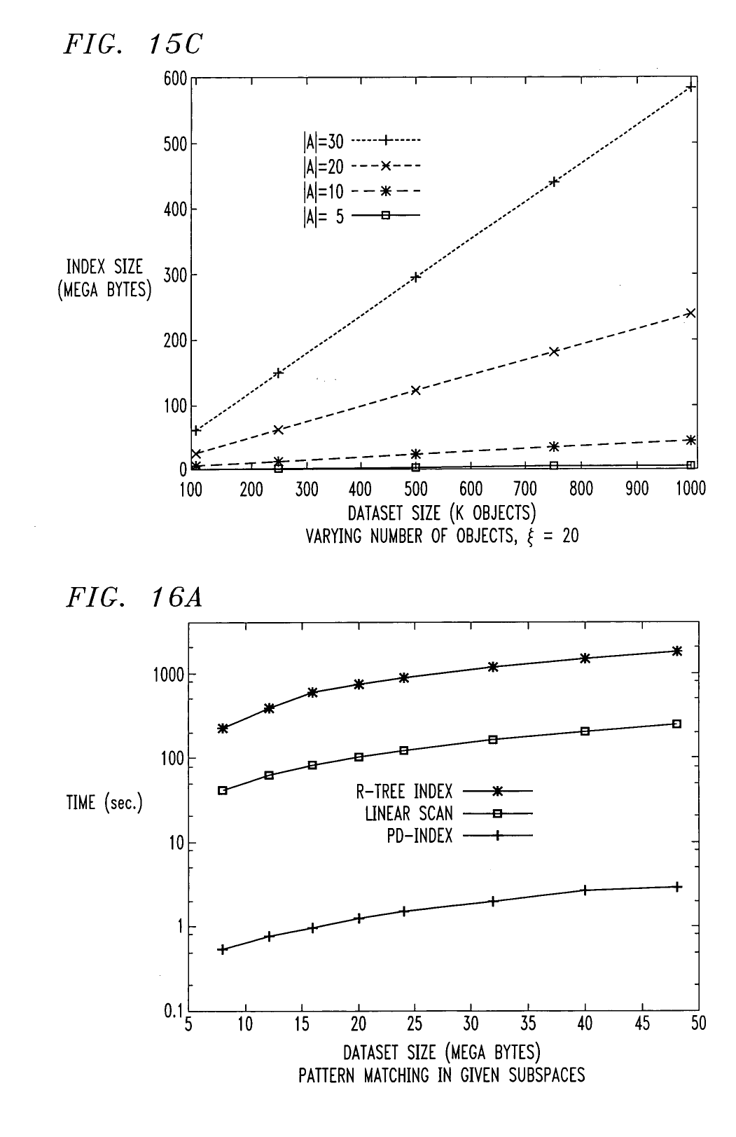

The space requirement of the pattern-distance index is linearly proportional to the data size as shown in FIGS. 15A-C. FIG. 15A is a graph illustrating a data set wherein the dimensionality is fixed and the discretization granularity varies. In FIG. 15A the dimensionality of the data is fixed at 20 and ξ, the discretization granularity, is changed from five to 80. It shows that ξ has little impact on the index size when the data size is small. When the data size increases, the growth of the trie slows down as each trie node is shared by more objects (this is more obvious for smaller ξ, as shown in FIG. 15A.

FIGS. 15B-C are graphs illustrating a data set wherein the discretization granularity is fixed and the dimensionality is varied. In FIGS. 15B-C, the discretization granularity ξ, is fixed at 20, while the dimensionality of the dataset varies. The dimensionality affects the index size. With a dataset of dimensionality |A|, the biggest pattern distance between two objects is |A|−1, i.e., they do not share patterns in any subspace of dimensionality larger than one.

However, given a query object q, it is of interest to find near-neighbors of q, that is, to find NN(q, r) wherein r is small. Thus, instead of inserting each suffix of an object sequence into the trie, only those suffixes of length larger than a threshold t are inserted. This enables the identification NN(q, r), wherein r≦|A|−t. For instance, for a 40 MB dataset of dimensionality |A| equals 80, restricting near-neighbor search within r less than or equal to eight reduces the index size by 71 percent.

The near-neighbor methodologies presented herein may be compared with two alternative approaches, namely i) brute force linear scan and ii) R-Tree family indices. The linear scan approach for near-neighbor search is straightforward to implement. The R-Tree, however, indexes values not patterns. To support queries based on pattern similarity, an extra dimension cᵢⱼ=cᵢ−cⱼ is created for every two dimensions cᵢ and cⱼ. Still, R-Tree index supports only queries in given subspaces and does not support finding near-neighbors that manifest patterns in any subspace of dimensionality above a given threshold.

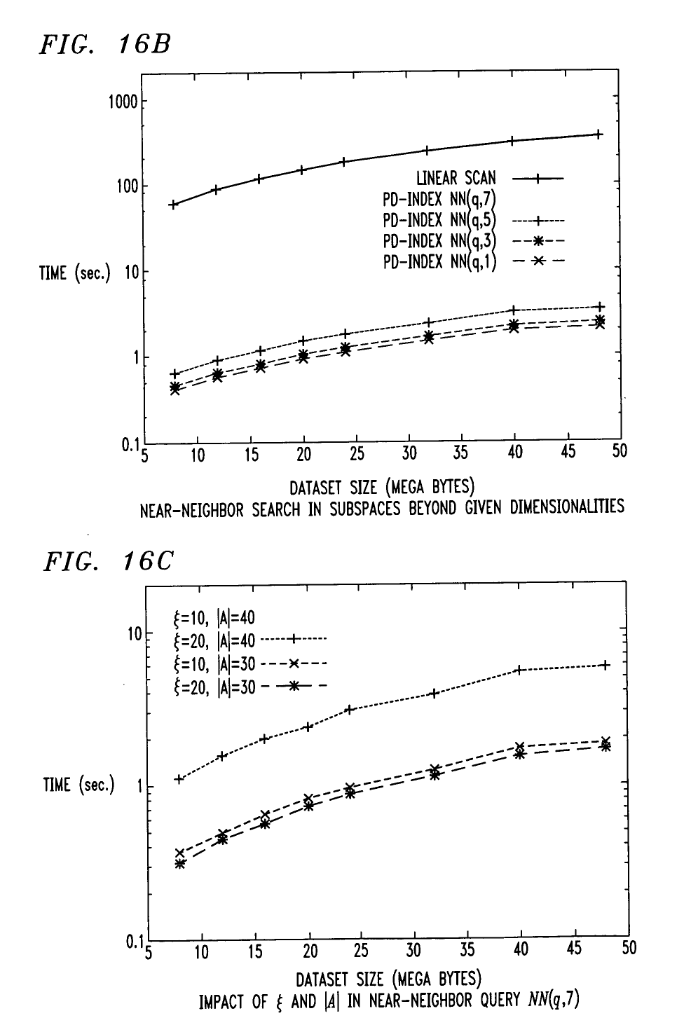

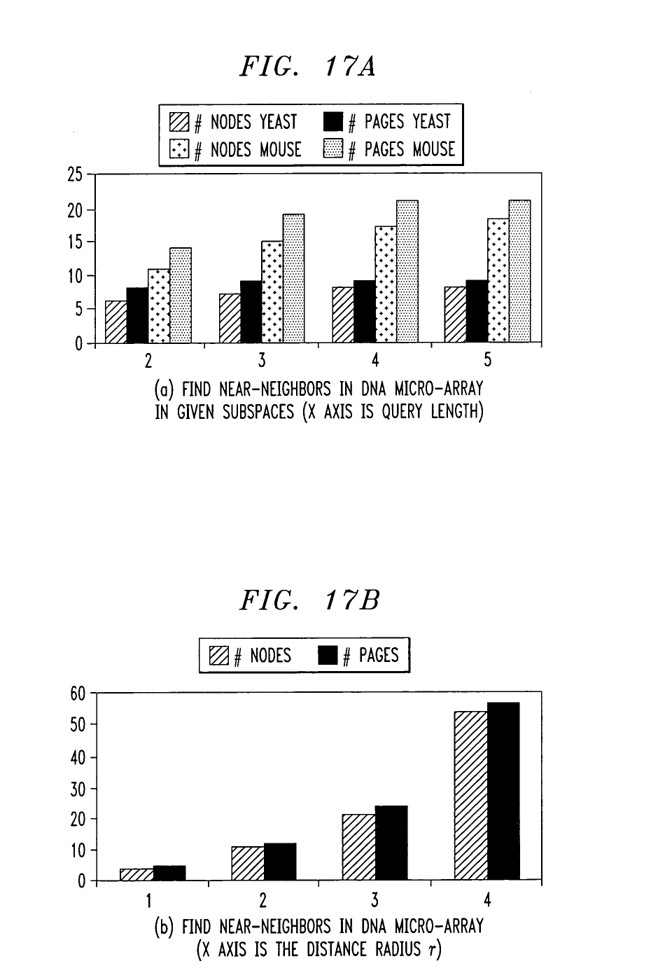

FIG. 16A is a graph illustrating pattern matching in given subspaces. The query time presented in FIG. 16A indicates that PD-Index scales much better than the two alternative approaches for pattern matching in given subspaces. The comparisons are carried out on synthetic datasets of dimensionality |A| equals 40 and discretization level ξ equal to 20. Each time, a subspace is designated by randomly selecting four dimensions, and random query objects are generated in the subspace. It is found that the R-Tree approach is slower than brute force linear-scan for two reasons: i) the R-Tree approach degrades to linear-scan under high-dimensionality and ii) the fact that the R-Tree approach indexes on a much larger dataset (with |A|²/2 extra dimensions) means that it scans a much larger index file. FIG. 16B is a graph illustrating a near-neighbor search in subspaces. In FIG. 16B results are shown of near-neighbor searches with different tolerance radiuses. PD-Index is much faster than linear-scan. The complexity of checking whether two objects manifest an ε-pattern* in a subspace of dimensionality beyond a given threshold is at least O(n log(n)), wherein n equals |A|.

Still, the response time of PD-Index increases rapidly when the radius expands, as a lot more branches have to be traversed in order to find all objects satisfying the criteria. FIG. 16C is a graph illustrating the impact of dimensionality and discretization granularity on a near-neighbor query. FIG. 16C also confirms that dimensionality is a major concern in query performance.

One approach to further improve the performance is to partition the dimension set into a set of groups. For instance, in target marketing, products can be grouped into categories, and in DNA microarray analysis, expression levels recorded by time can be grouped into moving windows of fixed time intervals. Finding near-neighbors in subspaces within each group is much more efficient.

To further analyze the impact of different query forms on the performance, the comparisons are based on number of disk accesses. First, random queries are asked against yeast and mouse DNA micro-array data in subspaces of dimensionality ranging from two to five. The selected dimensions are evenly separated. For instance, the dimension set {c₁, c₁₃, c₂₅, c₃₇, c₄₉} is selected in a mouse cDNA array that has a total of 49 conditions.

FIGS. 17A-B are graphs illustrating similarity matching for exemplary DNA micro-array data. FIG. 17A shows the average number of node accesses and disk accesses. Since PD-Index offers increased selectivity for longer queries, it is robust as the dimensionality of the given subspace becomes larger. In FIG. 17B near-neighbor queries NN(q)≦r, wherein r ranges from one to four are asked. The number of disk accesses increases when the radius is enlarged. There are two reasons for this phenomena, i) when the radius increases, the pruning procedure, as exemplified by the methodology shown in FIG. 12, becomes more tolerant and ii) a larger number of objects will satisfy the query.

Although illustrative embodiments of the present invention have been described herein, it is to be understood that the invention is not limited to those precise embodiments, and that various other changes and modifications may be made by one skilled in the art without departing from the scope or spirit of the invention.

1. A method for use in finding near-neighbors in a set of objects comprising the steps of:
identifying subspace pattern similarities that the objects in the set exhibit in multi-dimensional spaces; and
defining subspace correlations between two or more of the objects in the set based on the identified subspace pattern similarities for use in identifying near-neighbor objects.

2. The method of claim 1, wherein the identifying step further comprises the step of creating a pattern distance index.

3. The method of claim 1, wherein the multi-dimensional spaces comprise arbitrary spaces.

4. The method of claim 2, wherein the creating step further comprises the step of determining a subspace dimensionality of one or more patterns in the pattern distance index.

5. The method of claim 4, wherein the subspace dimensionality is an indicator of a degree of similarity between the objects.

6. The method of claim 1, wherein data relating to the objects is static.

7. The method of claim 1, wherein data relating to the objects comprises dynamic data insertions.

8. The method of claim 1, wherein data relating to the objects comprises gene expression data.

9. The method of claim 1, wherein data relating to the objects comprises synthetic data.

10. The method of claim 1, wherein identifying the subspace pattern similarities comprises a comparison of any subset of dimensions in the multi-dimensional spaces.

11. The method of claim 1, wherein identifying the subspace pattern similarities comprises an ordering of dimensions in the multi-dimensional spaces.

12. The method of claim 1, wherein each object is represented by a sequence of pairs, each pair indicating a dimension and an object value in that dimension.

13. The method of claim 12, wherein a first pair in the sequence of pairs comprises a base of comparison for one or more remaining pairs in the sequence of pairs.

14. The method of claim 12, wherein the sequence of pairs is represented sequentially in a tree structure comprising one or more edges and one or more nodes.

15. The method of claim 2, wherein creating the pattern distance index comprises use of pattern-distance links.

16. The method of claim 1, wherein the process is optimized by maintaining a set of embedded ranges.

17. The method of claim 1, wherein the subspace correlations comprise a distance between two or more of the objects in the set.

18. A method of performing a near-neighbor search of one or more query objects against a set of objects comprising the steps of:
creating a pattern distance index to identify subspace pattern similarities that the objects in the set exhibit in multi-dimensional spaces;
defining subspace correlations between two or more of the objects in the set based on the identified subspace pattern similarities; and
using the subspace correlations to identify near-neighbor objects among the query objects and the objects in the set.

19. An apparatus for use in finding near-neighbors in a set of objects, the apparatus comprising:
a memory; and
at least one processor, coupled to the memory, operative to:
identify subspace pattern similarities that the objects in the set exhibit in multi-dimensional spaces; and
define subspace correlations between two or more of the objects in the set based on the identified subspace pattern similarities for use in identifying near-neighbor objects.

20. An article of manufacture for finding near-neighbors in a set of objects, comprising a machine readable medium containing one or more programs which when executed implement the steps of:
identifying subspace pattern similarities that the objects in the set exhibit in multi-dimensional spaces; and
defining subspace correlations between two or more of the objects in the set based on the identified subspace pattern similarities for use in identifying near-neighbor objects.
